(19) United States
(12) Patent Application Publication
(10) Pub. No.: US 2026/0246629 A1
(43) Pub. Date: Aug. 20, 2026

(54) MOBILE DEVICE FOR OPERATING PERSONALIZED ON-DEVICE AI AGENT BASED ON PERSONAL DATA

(71) Applicant: BLOCKCHAIN LABS INC., Seoul (KR)

(72) Inventors: Yong Tae KIM, Seoul (KR); Byung Wan LIM, Seoul (KR); Jong Hoon PARK, Hanam-si (KR)

(73) Assignee: BLOCKCHAIN LABS INC., Seoul (KR)

(21) Appl. No.: 19/059,568

(22) Filed: Feb. 21, 2025

(30) Foreign Application Priority Data
Feb. 14, 2025 (KR) 10-2025-0019132

(51) Int. Cl. H04L 9/08

(52) U.S. Cl. CPC H04L 9/088

(57) ABSTRACT

The present disclosure relates to an electronic device including a first button to activate or deactivate an AI agent module, a memory, a first display and a second display to operate in an AI mode for displaying screens associated with operation of the AI agent module or in a normal mode for displaying screens associated with execution of applications, and at least one processor to, when the AI agent module is activated by the first button, activate the AI mode of the first display, when a target action of a target application included in the applications is executed, obtain at least a portion of data generated according to the execution of the target action, generate a data set including the obtained data and a device electronic signature generated based on a device private key associated with a device DID, add the data set into personal data.

### CROSS-REFERENCE TO RELATED APPLICATION

This application claims priority to Korean Patent Application No. 10-2025-0019132 filed on Feb. 14, 2025, and all the benefits accruing therefrom under 35 U.S.C. § 119, the contents of which are incorporated by reference in their entirety.

### BACKGROUND

Embodiments disclosed in this present disclosure relate to on-device artificial intelligence and small language model technologies.

The AI technology provided through smartphones is mainly limited to AI assistant models. The smartphone's AI assistant models perform roles that merely assist smartphone users, and particularly, due to the limited third-party applications compatible with AI assistant models, user experience is restricted as AI assistant models operate only on certain system applications, causing inconvenience to users, and failing to provide personalized experiences, thus not gaining user acceptance.

With the advancement of AI technology, attempts are being made to create personal AI agents capable of automatically performing tasks on behalf of individuals (users). Compared to AI assistants, personal AI agents aim to provide highly personalized experiences by deeply understanding and learning about users, and to go beyond merely assisting users to collaborate with them in performing tasks, generally, the personal AI agents are implemented to operate in multi-platform, multi-application environments.

### SUMMARY

To provide personal AI agent functionality in mobile electronic devices such as smartphones, the present disclosure is intended to provide an electronic device capable of operating on-device artificial intelligence models based on personal data.

The present disclosure proposes a form of mobile electronic device optimized for operating personal AI agent functions that can overcome the standardized interface of existing AI assistant models.

Furthermore, the present disclosure is intended to overcome the limited compatibility with third-party applications of existing AI models and provide personal AI agent functionality that operates on various applications installed in the electronic device.

An electronic device according to an embodiment disclosed in the present disclosure may comprise a first button configured to activate or deactivate an AI agent module, a memory configured to store personal data including a plurality of data sets associated with a user of the electronic device, a plurality of applications, and a device DID, a first display and a second display configured to operate in an AI mode for displaying screens associated with operation of the AI agent module or in a normal mode for displaying screens associated with execution of the plurality of applications, and at least one processor, wherein the at least one processor is configured to, when the AI agent module is activated by the first button, activate the AI mode of the first display, when a target action of a target application included in the plurality of applications is executed, obtain at least a portion of data generated according to the execution of the target action, generate a data set including the obtained data and a device electronic signature generated based on a device private key associated with the device DID, add the data set into the personal data, display a notification message associated with the generation of the data set on the first display, and display an execution screen of the target action on the second display.

According to embodiments disclosed in the present disclosure, a mobile device such as a smartphone can provide personal AI agent functionality that is compatible with multiple applications and operates based on personal data of a device user.

According to embodiments disclosed in the present disclosure, by dual display functionality operating in AI mode and normal mode, the electronic device can provide general functionality and personal AI agent functionality separately to users.

By utilizing a talking head model based on a user AI model, operation of the AI agent can be effectively visualized, and through mutual interaction between the mobile device and the talking head model, a personalized AI agent interface for a specific user can be provided rather than a standardized interface.

In addition, various effects may be provided that are directly or indirectly identified through the present disclosure.

### BRIEF DESCRIPTION OF THE DRAWINGS

FIG. 1 is a diagram for explaining an exterior appearance of an electronic device according to an embodiment.

FIG. 2 is a block diagram of an electronic device according to an embodiment.

FIG. 3 is a flowchart of a method for collecting personal data by an electronic device according to an embodiment.

FIG. 4 is a diagram illustrating normal mode and AI mode of a display of an electronic device according to an embodiment.

FIG. 5 is a flowchart of a method for processing a user query by an electronic device according to an embodiment.

FIG. 6 is a diagram illustrating an example of processing a query according to an embodiment.

FIG. 7 is a diagram illustrating an example of displaying source information of personal data included in a response generated for a query according to an embodiment.

FIG. 8 is a diagram illustrating another example of processing a query according to an embodiment.

FIG. 9 is a flowchart of a method for processing a call action of a call application by an electronic device according to an embodiment.

FIG. 10 is a diagram illustrating an example of a screen displayed by an electronic device when a call action of a call application is executed according to an embodiment.

With respect to the description of the drawings, the same or similar reference signs may be used for the same or similar elements.

### DETAILED DESCRIPTION OF EMBODIMENTS

Hereinafter, various embodiments of the present disclosure will be described with reference to the accompanying drawings. However, this is not intended to limit the present disclosure to the specific embodiments, and it is to be construed to include various modifications, equivalents, and/or alternatives of embodiments of the present disclosure.

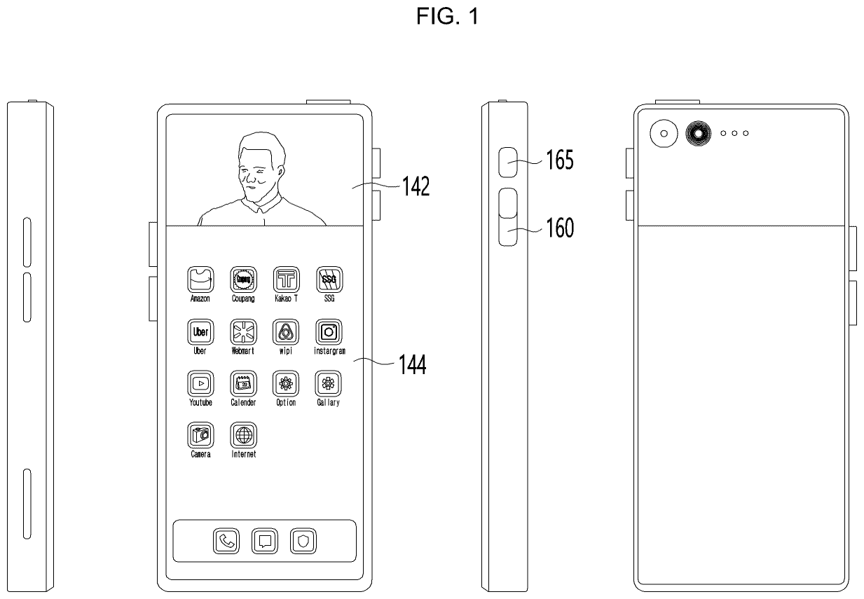

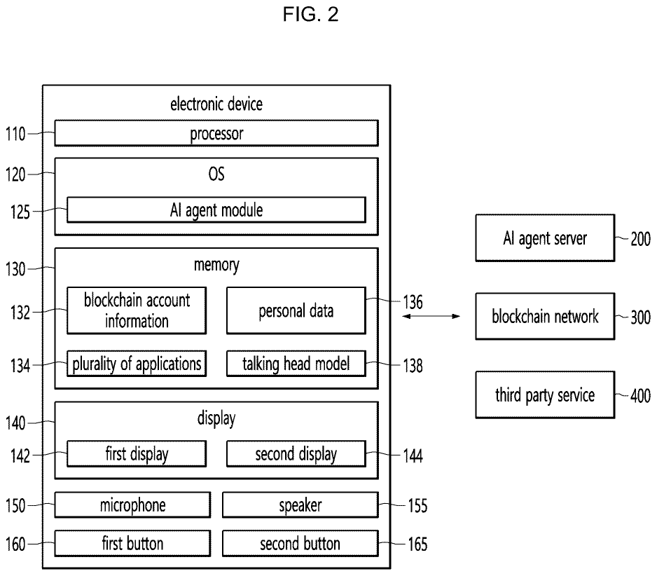

FIG. 1 is a diagram for explaining an exterior appearance of an electronic device 100 according to an embodiment. FIG. 2 is a block diagram of an electronic device 100 according to an embodiment. Hereinafter, the exterior appearance and configuration of the electronic device 100 will be described with reference to FIGS. 1 and 2.

The electronic device 100 may be understood as an electronic device designed to operate an AI agent module 125 mounted inside the electronic device 100. The exterior appearance shown in FIG. 1 is an example of the electronic device 100.

Referring to FIG. 2, the electronic device 100 may include a processor 110, a memory 130, a display 140, a communication module 150, a microphone 150, and a speaker 155.

The processor 110 may include one or more processors for controlling overall operations of the electronic device 100. The processor 110 may be operably connected to the memory 120 and configured to execute instructions stored in the memory 120.

The memory 120 may include blockchain account information 132 as identifier information of the electronic device 100 and/or the AI agent module 125, a plurality of applications 134 installed on the electronic device 100, personal data 136 storing data about a user of the electronic device 100, and a talking head model 138.

The AI agent module 125 may be understood as an artificial intelligence model implemented to operate the electronic device 100 on behalf of a user of the electronic device 100. Additionally, the AI agent module 125 may be understood as an on-device AI model and small Language Models (sLM) running on the electronic device 100. The AI agent module 125 may be installed on the operating system 112 of the electronic device 100 and control operations of the electronic device 100 (operations of the processor 110).

The electronic device 100 may include a first button 160 as a button for activating or deactivating the AI agent module 125. When the first button 160 is in an ‘ON’ state, the AI agent module 125 may be activated, and when the first button 160 is in an ‘OFF’ state, the AI agent module 125 may be deactivated.

The AI agent module 125 may receive a query from a user of the electronic device 100 and generate a response to the query. The AI agent module 125 may generate personalized responses based on personal data 136 for queries received from the user. The electronic device 100 may include a second button 165 for receiving queries. For example, the user of the electronic device 100 may input a query by pressing the second button 165 and speaking, or by inputting text.

Referring to FIG. 1, the first button 160 and the second button 165 may be configured as physical buttons on the electronic device 100. For example, the first button 160 may be configured as a selection button that can control two states of on/off. The second button may be configured as a push button. In various embodiments, the first button 160 and the second button 165 may also be configured as software buttons that can be input through touch on the display 140.

In an embodiment, the electronic device 100 and the AI agent module 125 may be configured to correspond to one blockchain account. The blockchain account may be a unique identifier for the electronic device 100 and the AI agent module 125. The blockchain account information 132 may include a Decentralized Identity (DID) of blockchain network 300 (hereinafter, referred to as device DID) which is an identifier of the electronic device 100 and the AI agent module 125, and a pair of public key and private key (hereinafter, referred to as device public key and device private key). In various embodiments, the device DID and the device public key may be identical.

The blockchain account information 132 may be generated by the operating system 120 and/or the AI agent module 125. The blockchain account information 132 may be generated according to manufacturer's design without user intervention. Therefore, an electronic signature generated based on the device private key may function as an electronic signature guaranteed by the manufacturer.

In various embodiments, the blockchain account information 132 of the electronic device 100 may be stored in the blockchain network 300 and configured to be accessible by third parties. Hereinafter, the device electronic signature described in the present disclosure may be understood as an electronic signature generated by the device private key associated with the device DID. Anyone can identify through the blockchain network 300 that the electronic signature was generated by the electronic device 100, and such electronic signature may be understood as being guaranteed by the manufacturer of the electronic device 100.

The applications 134 may include a plurality of applications installed on the electronic device 100. The plurality of applications may be understood as a list of software programs needed when using the electronic device 100 for general purposes. For example, the applications 134 may include various applications such as a phone application, a messenger application, a shopping application, etc.

The personal data 136 may include a plurality of data sets associated with a user of the electronic device 100. The personal data 136 may be generated by the electronic device 100 or by third-party services. Data sets generated by the electronic device 100 may include a device electronic signature. Data sets generated by third-party services may include an electronic signature of the service provider. These producer electronic signatures ensure reliability of the personal data 136 and make the personal data 136 verifiable. In various embodiments, the plurality of data sets included in the personal data 136 may be stored in the form of Verifiable Credentials (VC) according to W3C standardization specifications.

In various embodiments, the personal data 136 may be generated by the electronic device 100 or by third-party service providers. Each data set included in the personal data 136 may include an electronic signature of the generator of the data set. The generator's electronic signature may prove the source of the data set.

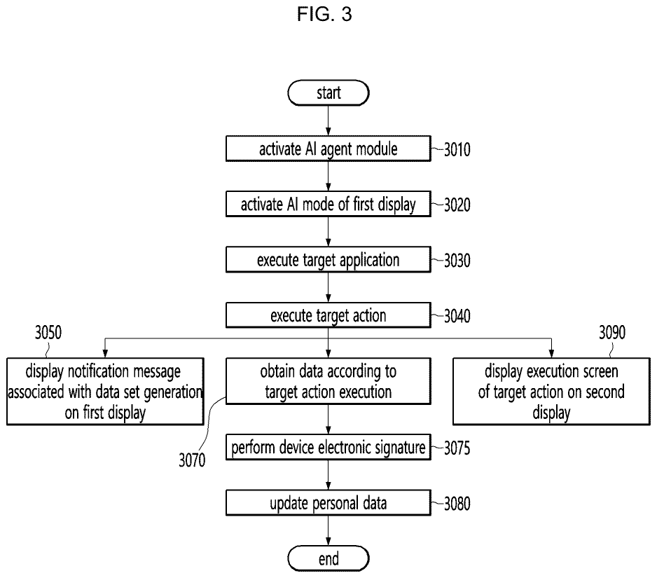

According to an embodiment, personal data 136 generated by the electronic device 100 may be collected from operations of the electronic device 100. For example, when an application is executed on the electronic device 100, various data may be input, output, or generated during the execution process. The electronic device 100 may store data that is input, output, or generated by a predetermined specific operation of a specific application into the personal data 136. This will be described in detail later through FIG. 3.

According to various embodiments, a data set generated by the electronic device 100 may include a name of an application, an action of an executed application, and associated content (e.g., data that is input/received or generated during action execution).

According to an embodiment, personal data 136 generated by third-party service providers may be provided by the third-party service providers upon a download request from the electronic device 100. Data generated while a user of the electronic device 100 uses various third-party services (hereinafter, referred to as user data) may be stored and managed by the third-party service providers. Meanwhile, various regulations are being implemented in different countries, such as the California Consumer Privacy Act, the European Union's General Data Protection Regulation (GDPR), and Japan's Act on the Protection of Personal Information (APPI). Therefore, third-party service providers have an obligation to provide user data to their service users. The electronic device 100 may obtain user data from third-party service providers through a download request for user data of the electronic device 100. The user data may include an electronic signature of the third-party service provider.

In various embodiments, the electronic device 100 may unify the format of data generated by the electronic device 100 and user data downloaded from third-party service providers, and integrate both to store in the personal data 136.

According to an embodiment, the electronic device 100 may generate a user AI model that operates with the user's face and voice by using a voice AI model trained based on voice data of the user of the electronic device 100 and an avatar AI model trained based on the user's photos or videos. The at least one user AI model may visualize at least some operations of the AI agent module 125. The talking head model 138 may include at least one user AI model. Unlike existing AI assistant models having standardized interfaces limited to the role of user's assistant, the talking head model 138 enables effective expression of the AI agent module 125 that can operate the electronic device 100 like a user based on the user's personal data on behalf of the user of the electronic device 100. The talking head model 138 may function as a user interface expressing the AI agent module 125.

In an embodiment, the electronic device 100 may generate the talking head model 138. For example, an onboarding process for the talking head model 138 may be included in a setup process of a newly shipped electronic device 100. The onboarding process may include receiving voice data and face data (photos or videos) from the user of the electronic device 100. For example, the electronic device 100 may display an interface that makes the user speak for more than a predetermined time and generate voice data according to the speech. The electronic device 100 may display an interface that makes the user input more than a predetermined number of face photos or input face videos for more than a predetermined time, and obtain face photos or face videos. The electronic device 100 may generate the talking head model 138 based on the input voice data and face data (face photos or face videos). In various embodiments, the talking head model 138 may be generated and controlled by the AI agent module 125.

In an embodiment, the display 140 may include a first display 142 and a second display 144. The first display 142 and the second display 144 may operate as one display 140, or display different content. In various embodiments, the display 140 may be configured as either a single display device or two separate display devices divided into the first display 142 and the second display 144. In the former case, the display 140 may operate divided into a first area (corresponding to the first display 142) and a second area (corresponding to the second display 144). According to operations of the electronic device 100, the display 140 may display a single screen, or display different screens through the first display 142 (first area) and the second display 144 (second area). In the latter case, the first display 142 and the second display 144 may display a single screen or different screens according to operations of the electronic device 100.

The first display 142 and the second display 144 may operate in an AI mode for displaying screens associated with operation of the AI agent module 125 or in a normal mode for displaying screens associated with execution of a plurality of applications 134 installed in the electronic device 100.

In various embodiments, the AI agent module 125 may perform operations in cooperation with an AI agent server 200. The AI agent server 200 may include other personal AI agent that operates in a one-to-one matching with the AI agent module 125 of the electronic device 100. The other personal AI agent included in the AI agent server 200 may be understood as an artificial intelligence model being operated on a server. The AI agent server 200 may include a personal database (not shown) that operates in conjunction with the personal data 136 of the electronic device 100. The AI agent module 125 and the AI agent server 200 may provide personalized responses based on the personal data 136 and the personal database.

FIG. 3 is a flowchart of a method for collecting personal data 136 by an electronic device 100 according to an embodiment. During operation of the electronic device 100, the AI agent module 125 may collect data associated with a user and store the collected data into the personal data 136. The collected personal data 136 may be used by the AI agent module 125 to provide user-customized responses. The personal data 136 generated through the method of FIG. 3 described below may include a device electronic signature as data generated by the electronic device 100.

When the AI agent module 125 is activated (3010), the electronic device 100 may activate the AI mode of the first display 142 (3020). For example, when the first button 160 is in an ‘ON’ state, the AI agent module 125 may be activated.

When a target action of a target application included in a plurality of applications is executed (3030, 3040), the electronic device 100 may obtain at least a portion of data generated according to the execution of the target action (3070), and generate a data set by performing an electronic signature (device electronic signature) based on the device private key on the obtained data (3075). The electronic device 100 may add the data set to the personal data 136 (3080). Since the data set includes the device electronic signature, anyone can verify the generator of the data set through the blockchain network 300. Through the device electronic signature, it can be verified that the source of the data set is the manufacturer of the electronic device 100, and that the data set is guaranteed by the manufacturer of the electronic device 100. In various embodiments, the data set may be in VC format.

In various embodiments, target applications and target actions that are subject to data collection may be preset. The target applications and target actions may be preset by the AI agent module 125. Alternatively, target applications and target actions may be set based on categories or functions for which the user wants personalized AI services.

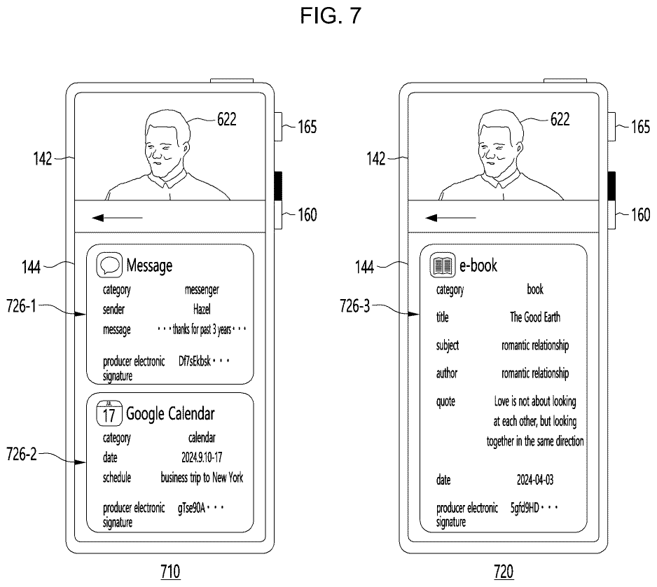

In various embodiments, the data set may further include a name of the target application, a category of the target application, and content associated with the target action. Embodiments of the data set will be described later through FIG. 7.

In various embodiments, the plurality of applications 134 may include default applications (system applications) installed by the manufacturer of the electronic device 100 and third-party applications created by third-party service providers. According to various embodiments, in operation 3070, the electronic device 100 may obtain data in different ways depending on whether the target application is a default application or a third-party application.

In the case of default applications, since data generated according to the execution of the default applications is stored in the electronic device 100 or storage associated with the electronic device 100 (e.g., manufacturer cloud), the electronic device 100 may have access and management rights to the data. Therefore, personal data 136 associated with default applications may be generated based on data stored in the electronic device 100 or the storage associated with it. According to various embodiments, in operation 3070, when the electronic device 100 obtains data to generate personal data 136 from the default applications, data according to target action execution (e.g., content associated with the target action) may be obtained from data stored in the electronic device 100 or the storage associated with it.

In the case of third-party applications, data generated according to the execution of third-party applications is stored and managed by third-party service providers. Therefore, the electronic device 100 may generate personal data 136 associated with the third-party applications based on information extracted from execution screens of third-party applications. For example, when a third-party application is set as a target application, the electronic device 100 may capture the execution screen displayed on the display 140 when the target action of the target application is executed. According to various embodiments, in operation 3070, the electronic device 100 may obtain data according to target action execution (e.g., content associated with the target action) from image/video data and text data included in the captured screen.

The electronic device 100 may display a notification message associated with the generation of the data set on the first display 142 (3050). The first display 142 in AI mode may display the notification message of information about the newly generated data set by an activity of the AI agent module 125.

The electronic device 100 may display an execution screen of the target action on the second display 144 (3090). The second display 144 in normal mode displays information according to the execution of the target action of the target application of the electronic device 100.

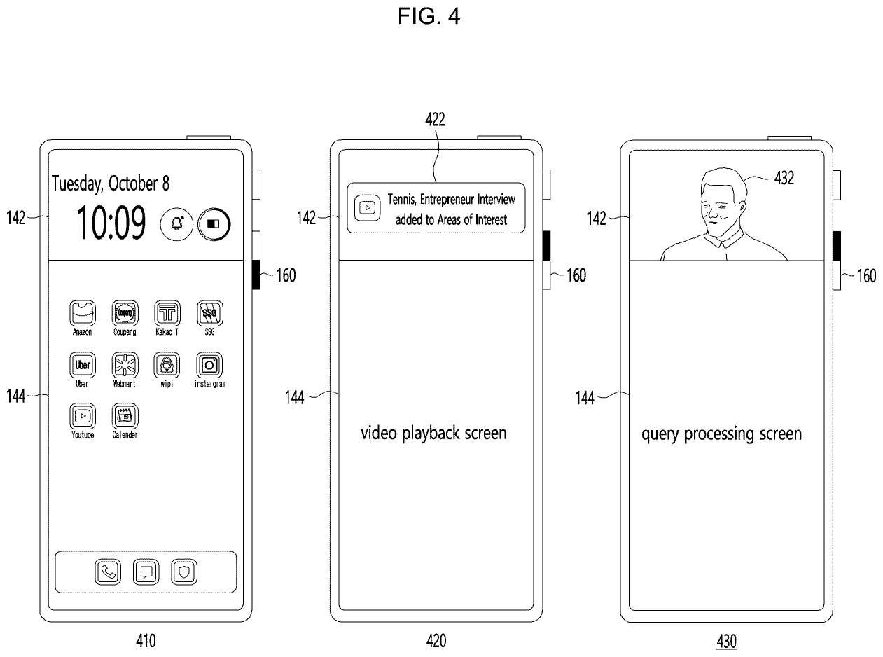

FIG. 4 is a diagram illustrating normal mode and AI mode of a display 140 of an electronic device 100 according to an embodiment. The AI mode may be understood as a screen mode configured to display information associated with operation of the AI agent module 135, and the normal mode may be understood as a screen mode configured to display information associated with operation of the electronic device 100 other than operation of the AI agent module 135.

Screen 410 is an example when the first display 142 and the second display 144 are in normal mode. For example, the first display 142 may display information such as date and time information and battery level information, and the second display 144 may display the plurality of applications 134 installed on the electronic device 100.

Screen 420 is an example when the first display 142 is in AI mode and the second display 144 is in normal mode. For example, screen 420 is a screen when a video playback action of a video platform program is executed. The second display 144 may display a video playback screen as an execution screen of the video playback action of the video platform program. The first display 142 displays a notification message 422 (e.g., the notification message of operation 3050 in FIG. 3) generated according to the video playback action of the video platform program. The notification message 422, as a message associated with the generation of a data set added to the personal data 136, may include summary information of the generated data set (‘Tennis, Entrepreneur Interview added to Areas of Interest’). The electronic device 100 may store the subjects of videos played through the video platform program as areas of interest in the personal data 136.

In various embodiments, the notification message 422 corresponding to generation of a data set to be added to the personal data 136 may further include a cancel button (not shown). For example, a user may request cancellation for a data set that the user does not want to be added to their personal data 136. When the electronic device 100 receives an input for the cancel button, the electronic device 100 may delete the generated data set without adding it to the personal data 136.

Screen 430 is an example about the case that both the first display 142 and the second display 144 are in AI mode. For example, screen 430 is an example of a screen where the AI agent module 125 receives a query from a user and displays a response to the query. For example, the second display 144 may display a query processing screen. The query processing screen may include the query and the response to the query. The first display 142 may display a user AI model included in the talking head model 432 (e.g., the talking head model 138 of FIG. 1). For example, the talking head model 432 displayed on the first display 142 in screen 430 may be a user AI model speaking the response to the query. The response to the query may be displayed in text form on the second display 144. The speech of the talking head model 432 may be output through the speaker 155, and the electronic device 100 may generate face video data of the user speaking the speech content using the talking head model 138, and display (play) it on the first display 142.

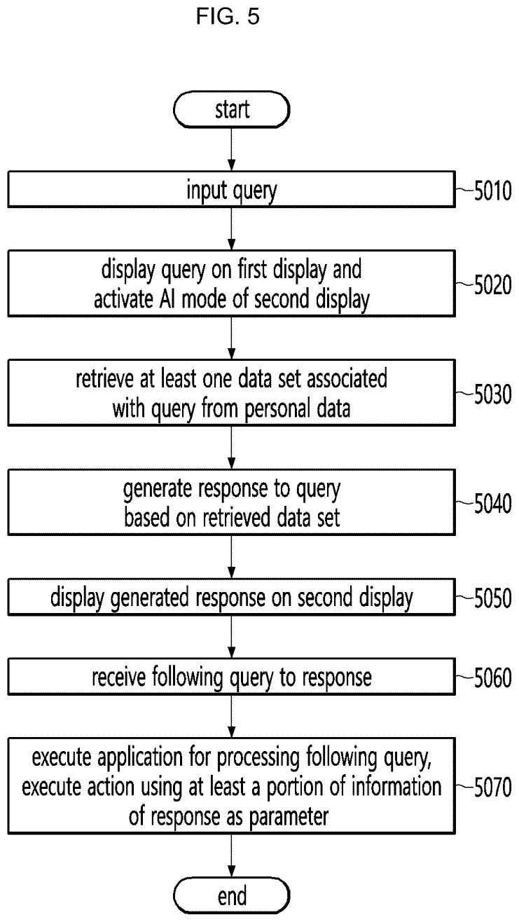

FIG. 5 is a flowchart of a method for processing a user query by an electronic device 100 according to an embodiment.

The electronic device 100 may receive a query (5010). The query may be understood as a request or command for using the AI agent module 125 of the user of the electronic device 100.

According to various embodiments, in operation 5010, the electronic device 100 may obtain user speech data through the microphone 150 and receive the query converted to text from the user speech data. For example, the user speech data may be obtained after receiving a push input for the second button 165. When the second button 165 is pressed by the user for more than a predetermined time, the AI agent module 125 may change to a state waiting for query input.

When a query is input, the electronic device 100 may display the input query on the first display 142 and activate the AI mode of the second display 144 (5020).

The electronic device 100 may retrieve at least one data set associated with the query from the personal data 136 (5030), and generate a response to the query based on the retrieved at least one data set (5040). The electronic device 100 may display the generated response on the second display 144 (5050).

According to various embodiments, in operation 5040, the electronic device 100 may compose a prompt based on the retrieved at least one data set and transmit the prompt to an external LLM server. The electronic device 100 may generate a response to the query based on text data received from the LLM server and the retrieved at least one data set.

According to various embodiments, in operation 5050, the electronic device 100 may generate voice data based on the generated response and output the voice data through the speaker 155. For example, the electronic device 100 may generate voice data that explains all or part of the generated response by voice. The voice data may be user voice data generated based on the talking head model 138.

According to various embodiments, in operation 5050, the electronic device 100 may display the talking head model 138 on the first display 142. Based on the talking head model 138, the electronic device 100 may convert the response generated in operation 5040 into voice data and output the voice data through the speaker 155, while simultaneously generating video data in which a face of the user speaking the response is played, and output the video data through the first display 142.

The electronic device 100 may receive a following query to the response (5060). The following query may be understood as a follow-up request to the response. The electronic device 100 may execute an application for processing the following query, and execute an action on the application using at least a portion of information of the response to the query generated in operation 5040 as a parameter (5070).

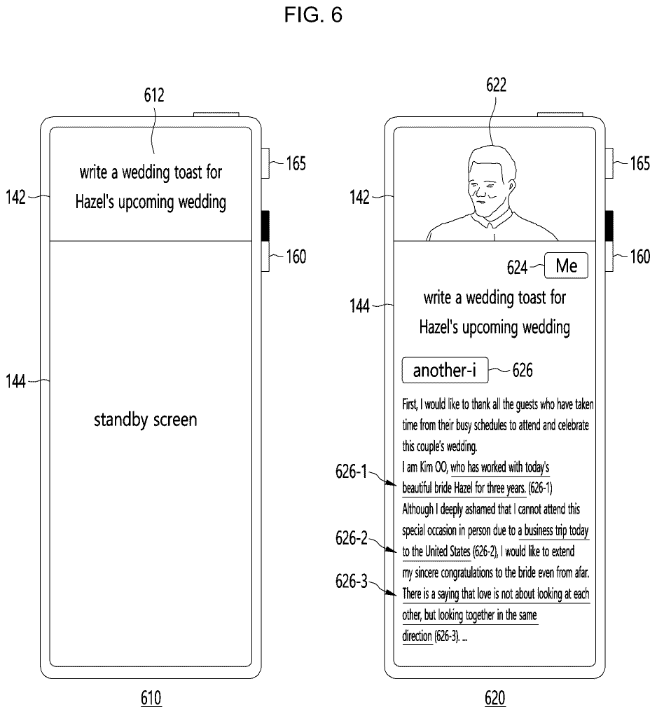

FIG. 6 is a diagram illustrating an example of processing a query according to an embodiment. FIG. 7 is a diagram illustrating an example of displaying source information of personal data 136 included in a response generated for a query according to an embodiment. Hereinafter, an example of processing a query “Write a wedding toast for Hazel's upcoming wedding” will be described with reference to FIGS. 6 and 7.

Referring to screen 610, the first display 142 displays the input query. For example, the query may be input through user speech after a push input of the second button 165 for more than a predetermined time. When AI mode of the second display 144 is activated according to the query input, a standby screen that can display operation of the AI agent module 125 may be displayed on the second display 144.

When a response to the input query is generated, the display 140 may display screen 620. Referring to screen 620, the first display 142 may display the talking head model 622 (e.g., the talking head model 138 of FIG. 2). The electronic device 100 may convert the response generated by the AI agent module 125 into voice data through the talking head model 622 and output the voice data through the speaker 155. Through the talking head model 622, the electronic device 100 may output video data through the first display 142 in which a face of the user speaking the response generated by the AI agent module 125 is played. The second display 144 may display the query of the user and the response 626 of the AI agent module 125 to the user query 624 in the form of a chat window.

The response 626 of the AI agent module 125 to the query of the user may include a first area 626-1, 626-2, 626-3 configured based on at least one data set retrieved from personal data 126 and a second area generated by the AI agent module 125. The first area 626-1, 626-2, 626-3 and the second area may be displayed distinctively, and for example, referring to screen 620, the first area 626-1, 626-2, 626-3 is highlighted with underlines, while the second area is displayed without underlines.

In an embodiment, when a selection input for the first area 626-1, 626-2, 626-3 is received, the electronic device 100 may display metadata of the at least one data set as source information of the first area 626-1, 626-2, 626-3 on the second display 144.

Referring to screen 710 of FIG. 7, a first data set 726-1 is displayed as source information for the first area 626-1. The first data set 726-1 may be understood as personal data 136 stored in response to a message receiving action of a message application. The first data set 726-1 may include a device electronic signature (an electronic signature generated based on a device private key associated with a device DID of the electronic device 100) as a producer electronic signature. ‘Message’ may be understood as a default application (system application) of the electronic device 100. Since the first data set 726 obtained from messages received through the message application includes a device electronic signature, anyone can verify the source of the first data set 726 through the device electronic signature.

Referring to screen 710, a second data set 726-2 is displayed as source information for the first area 626-2. The second data set 726-2 may be understood as personal data 136 downloaded from a calendar application as a third-party service. For example, if the calendar application provider is Google, the second data set 726-2 may be data downloaded from Google. In this case, the second data set 726-2 may include an electronic signature of Google as a producer electronic signature. Anyone can verify the source of the second data set 726-2 through the electronic signature of Google included in the second data set 726-3. In various embodiments, the second data set 726-2 may be data generated from execution screens captured by the electronic device 100 while the calendar application as a third-party service is running. In this case, the second data set 726-2 may include a device electronic signature as a producer electronic signature. Referring to screen 720, third data set 726-3 is displayed as source information for the first area 626-3. The third data set 726-3 may be understood as personal data 136 stored in response to an action to highlight text of an e-book application. The third data set 726-3 may include a device electronic signature as a producer electronic signature. Anyone can verify the source of the third data set 726-3 through the device electronic signature.

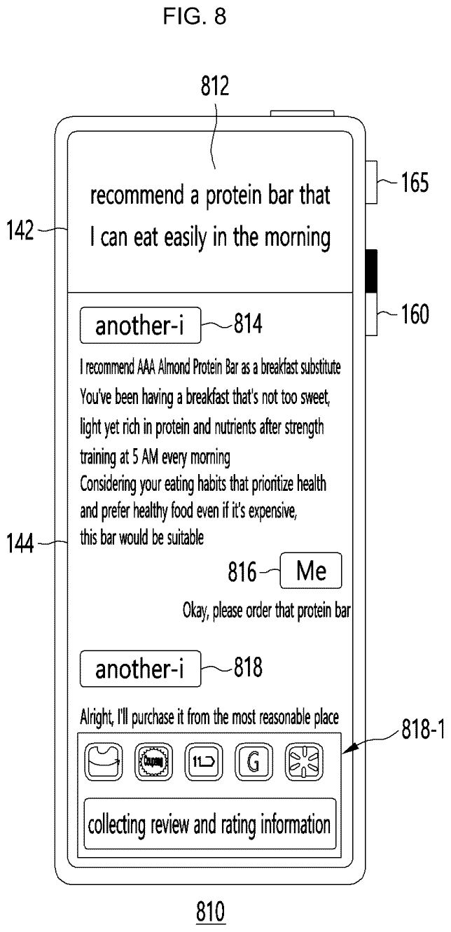

FIG. 8 is a diagram illustrating another example of processing a query according to an embodiment. An example of processing a query “Recommend protein bars that I can eat easily in the morning” will be described with reference to FIG. 8.

Referring to screen 810, the electronic device 100 may display the input query 812 on the first display 142. The electronic device 100 may generate a response 814 to the query 812 and display the generated response 814 on the second display 144. The electronic device 100 may receive a following query 816 to the response 814 (e.g., the following query of operation 5060 in FIG. 5). The following query 816 may be understood as a follow-up request to the response 814.

The electronic device 100 may execute a plurality of applications 818-1 of a shopping category to process the following query 816. The AI agent module 125 may perform product search on the plurality of applications 818-1 using information ‘AAA Almond Protein Bar’ included in the response 814 as a parameter. The AI agent module 125 may analyze reviews and ratings of products searched from the plurality of applications 818-1. Based on the analysis results, the AI agent module 125 may execute a purchase action for the most reasonable product. The series of processes from product search, review and rating analysis, to purchase may be displayed through the second display 144. By displaying the operation process of the AI agent module 125 on the second display 144, the electronic device 100 may allow the user of the electronic device 100 to view the processing steps of the AI agent module 125.

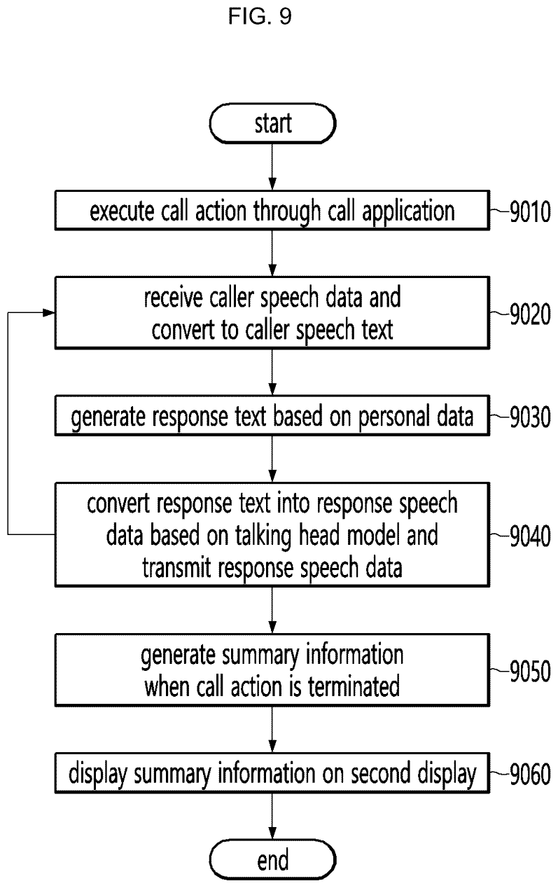

FIG. 9 is a flowchart of a method for processing a call action of a call application by an electronic device 100 according to an embodiment. For example, the method according to FIG. 9 may be performed when a call action is performed while the AI agent module 125 of the electronic device 100 is activated, or when the AI module 125 is activated by the first button 160 when the call action starts.

A call action through a call application may be executed on the electronic device 100 (9010), and the electronic device 100 may receive caller speech data from a caller device and convert the caller speech data into text to generate caller speech text (9020). The electronic device 100 may generate response text to the caller speech text based on the personal data 136 (9030).

The electronic device 100 may convert the response text into response speech data (voice data) based on the talking head model 138 and transmit the response speech data to the caller device (9040). The electronic device 100 may convert the response text into response speech data based on a voice AI model trained based on voice data of a user included in the talking head model 138. Through operation 9040, the caller can proceed with a conversation with the recipient's talking head model 138. Even in the absence of the user, the electronic device 100 can directly perform calls on behalf of the user based on the personal data 136 previously stored in the electronic device 100.

In various embodiments, a video call action may be executed through the call application of the electronic device 100. In operation 9040, the electronic device 100 may generate video data in which a face of the user speaking the voice speech data is played based on the talking head model 138. The electronic device 100 may transmit the response speech data and the video data to the caller device. In video call actions according to various embodiments, the electronic device 100 may display video data (caller's face) received from the caller device on the second display 144, and display video data generated using the talking head model 138 on the first display 142.

When the call action is terminated, the electronic device 100 may generate summary information of the call action based on caller speech text and response text generated during the call action (9050). The electronic device 100 may activate the AI mode of the second display 144 and display the generated summary information on the second display 144 (9060).

The summary information may include caller information, content information generated based on caller speech text and response text, and personal data 136 used by the electronic device 100 to generate the response text. Through the summary information, the user can understand the content of the call performed on behalf of the user.

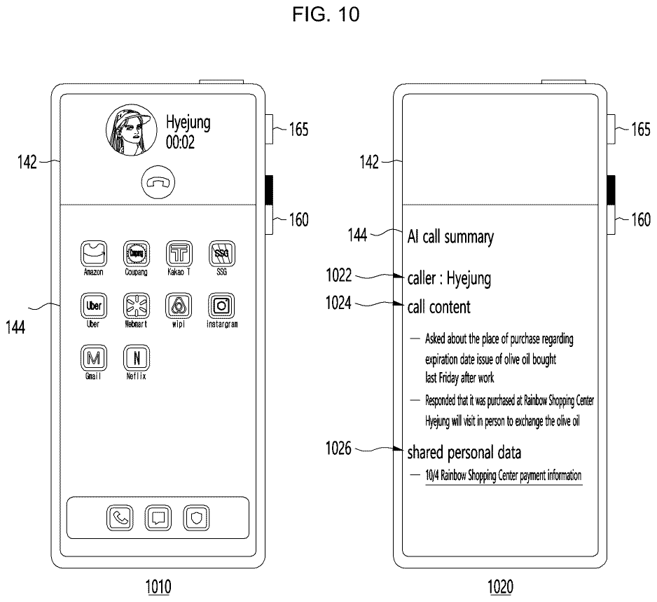

FIG. 10 is a diagram illustrating an example of a screen displayed by an electronic device 100 when a call action of a call application is executed according to an embodiment. Referring to screen 1010, the first display 142 may display information related to the ongoing call action. Information related to the ongoing call action may include, for example, caller information and call duration. Referring to screen 1020, summary information generated after the call action is terminated may be displayed on the second display 144. The summary information may include caller information 1022, call content 1024, and shared personal data 1026. It can be confirmed that the response data in the call content was generated by the shared personal data 1026. The shared personal data 1026 may be understood as summary information of a data set included in personal data 136, and when an item of the shared personal data 1026 is clicked, source information for each item may be displayed (e.g., source information of personal data 136 in FIG. 7).

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar or related reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). When a component (e.g., a first component) is referred to as being “coupled” or “connected” to another component (e.g., a second component), with or without the terms “functionally” or “communicatively,” it means that the component can be connected to the other component directly (e.g., wired), wirelessly, or through a third component.

Various embodiments as set forth herein may be implemented as software including one or more instructions that are stored in a storage medium that is readable by the electronic device 100. For example, a processor (e.g., the processor 110) of the electronic device 100 may invoke at least one of the one or more instructions stored in the storage medium, and execute the invoked instruction. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to various embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single subject or multiple subjects. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as those performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a first button configured to activate or deactivate an AI agent module;
a memory configured to store personal data including a plurality of data sets associated with a user of the electronic device, a plurality of applications, and a device DID;
a first display and a second display configured to operate in an AI mode for displaying screens associated with operation of the AI agent module or in a normal mode for displaying screens associated with execution of the plurality of applications; and
at least one processor,
wherein the at least one processor is configured to:
when the AI agent module is activated by the first button, activate the AI mode of the first display,
when a target action of a target application included in the plurality of applications is executed, obtain at least a portion of data generated according to the execution of the target action,
generate a data set including the obtained data and a device electronic signature generated based on a device private key associated with the device DID,
add the data set into the personal data,
display a notification message associated with the generation of the data set on the first display, and
display an execution screen of the target action on the second display.

2. The electronic device of claim 1,
wherein the at least one processor is configured to generate the data set including a name of the target application, a category of the target application, and contents associated with the target action.

3. The electronic device of claim 2,
wherein the at least one processor is configured to:
receive a query for using the AI agent module,
display the query on the first display,
activate the AI mode of the second display,
retrieve at least one data set associated with the query from the personal data,
generate a response to the query based on the retrieved at least one data set, and
display the response on the second display.

4. The electronic device of claim 3,
wherein the memory includes a talking head model trained based on voice data and face data of the user of the electronic device, and
wherein the at least one processor is configured to:
convert the response, which is text data, into voice data based on the talking head model,
output the converted voice data through a speaker,
generate video data in which a face of the user speaking the voice data is played based on the talking head model, and
output the video data on the first display.

5. The electronic device of claim 3,
wherein the response includes a first area configured based on the retrieved at least one data set and a second area generated by the AI agent module, and
wherein the at least one processor is configured to:
when a selection input for the first area is received, display metadata of the at least one data set on the second display as source information of the first area.

6. The electronic device of claim 3,
wherein the at least one processor is configured to:
when a following query to the response is received, execute an application for processing the following query, and
execute an action on the application using at least a portion of information of the response as a parameter.

7. The electronic device of claim 4,
wherein the at least one processor is configured to:
when a call action through a call application is executed, caller speech data is received from a caller device,
convert the caller speech data into text to generate caller speech text,
generate response text to the caller speech text based on the personal data,
convert the response text into response speech data based on the talking head model, and
transmit the response speech data to the caller device.

8. The electronic device of claim 7,
wherein the at least one processor is configured to:
when the call action is terminated, generate summary information on call content based on the caller speech text and the response text,
activate the AI mode of the second display, and
display the summary information on the second display.

9. The electronic device of claim 7,
wherein the at least one processor is configured to:
generate video data in which a face of the user speaking the response speech data is played based on the talking head model, and
transmit the response speech data and the video data to the caller device.
